(19) United States
(12) Patent Application Publication
(10) Pub. No.: US 2008/0022250 A1
(43) Pub. Date: Jan. 24, 2008

(54) Chip finishing using a library based approach

(76) Inventors: Charudhattan Nagarajan, Bangalore (IN); Umesh K.N., Bangalore (IN)

Correspondence Address: David Aker, 23 Southern Road, Hartsdale, NY, 10530, US

(21) Appl. No.: 11/490,417

(22) Filed: Jul. 20, 2006

(51) Int. Cl. G06F 17/50

(52) U.S. Cl. 716/10

(57) ABSTRACT

A method, software in the form of a computer readable medium, and a system for designing an integrated circuit. The method comprises providing in a library of shapes, a at least one shape used to define regions of the integrated circuit in which no active chip circuits are placed; and utilizing the library to design the integrated circuit. GDS data corresponding to the design of the integrated circuit includes data representing said at least one shape as a dummy element.

### BACKGROUND OF THE INVENTION

1. Field of the Invention

The present invention relates to apparatus, methods and software used in the design of integrated circuits. More particularly, it relates to those apparatus, methods and software which are used to assist in finishing the design of an integrated circuit or chip, and compiling the data which must be sent to a chip foundry in order to produce the chip.

2. Background Art

The design of integrated circuits is a complex, costly and labor intensive undertaking that is carried out with the aid of sophisticated software. In addition to laying out millions of transistors and other electronically useful regions on a large scale integrated circuit, and having to specify the paths of interconnection between them, it is also necessary to specify which regions of the silicon on which the integrated circuit is formed can not be used. There must be regions between the chips on a silicon wafer in both the X and Y directions to provide space for lines along which the silicon may be removed (cut) to separate the chips or dies. No part of the circuit formed on any chip may be in this so called kerf region.

Generally, the design of an integrated circuit culminates in the preparation of a so called GDS (or GDSII) file containing almost all of the data needed by the foundry to produce the chip. After the integrated circuit has been designed, data is added to the GDS (or GDSII) file concerning shapes needed to be sure that portions of the circuitry of the chips do no fall within the kerf regions. This is done by adding data concerning certain special geometric configurations to the GDS data, after the chip has been designed. These shapes include:

CHIPEDGE: A basically rectangular shape enclosing all of the chip design. The dummy design level of this shape must encompass all active chip design shapes. The shape is used for merging kerf data. This shape must be bounded at X=0 on the left side of the chip, and at Y=0 at the bottom of the chip. The positioning of other shapes, such as PROTECT and GUARDRNG, in the GDS data depends on CHIPEDGE.

PROTECT: A triangular corner shape, four of which, when merged with CHIPEDGE, produce a rectangular frame around the active chip region.

GUARDRNG: The Chip guard ring provides both a low resistance path to ground for surge currents and a metal seal against contaminants. GUARDRNG is the name of the design layer that is used to form the guard ring.

Adding the above shapes to the GDS data after the chip design is otherwise complete, causes it to be added at a very critical phase of the overall chip design process. Drawing the CHIPEDGE shapes requires the use of a chip layout editor tool and requires a large amount of time and effort to achieve the correct geometric dimensions in accordance with the ground rules specified by the foundry. Further the results of this substantial effort can not be re-used for a different chip design. Thus, it would be of great benefit to provide a method of chip design, apparatus for designing a chip, and appropriate software to avoid the need for adding special geometric configurations to the GDS data after the design of the chip is essentially complete. It appears that there is no know manner of avoiding this situation.

### SUMMARY OF THE INVENTION

It is an object of the invention to provide a method, apparatus and software for avoiding time consuming and labor intensive efforts needed to define regions that cannot be used at the conclusion of the chip design process.

It is a further object of the invention to provide library elements representative of shapes of regions of the integrated circuit in which active circuitry may not be placed.

It is another object of the invention to integrate data concerning library elements representative of shapes of regions of the integrated circuit in which active circuitry may not be placed during the active design phase, rather than at the chip finishing phase of the design.

These objects and others are achieved in accordance with the invention by a method for designing an integrated circuit, comprising providing in a library of shapes, at least one shape used to define regions of the integrated circuit in which no active chip circuits are placed; and utilizing the library to design the integrated circuit. The method can further comprise forming graphic data system data corresponding to the design of the integrated circuit, said graphic data system data including data representing said at least one shape. The at least one shape can comprise a generally frame shape around the active region of an integrated circuit; and corner protect regions at the corners of the frame; wherein said frame shape and said corner regions do not overlap, but combine to form a rectangular frame around said active region of said integrated circuit. Generally, the at least one shape conforms to ground rules for design of the integrated circuit.

The method can further comprise providing data files associated with the shapes, the data files including a verilog description, a library exchange format file and a graphic data system file. Preferably, at least one of shapes is added to said library as a dummy library element. The design, including said shapes, is generally instantiated as a final verilog or vhdl netlist. The method can further comprise merging all data of the design into a graphic data system file, for all design components.

The invention is also directed to a computer readable medium having computer readable code thereon for causing a processor in a computer to perform steps in the design of an integrated circuit, the computer code causing the processor to perform steps comprising accessing in a library of shapes, a at least one shape used to define regions of the integrated circuit in which no active chip circuits are placed; and utilizing the library to design the integrated circuit. The medium can further comprising computer code for forming graphic data system data corresponding to the design of the integrated circuit, said graphic data system data including data representing said at least one shape. The medium can further include computer code for causing one of said shapes to comprise: a generally frame shape around the active region of an integrated circuit; and corner protect regions at the corners of the frame; wherein said frame shape and said corner regions do not overlap, but combine to form a rectangular frame around said active region of said integrated circuit.

The computer code on the medium will generally cause said at least one shape to conform to ground rules for design of the integrated circuit. The medium can further comprise computer code for providing data files associated with the shapes, the data files including a verilog description, a library exchange format file and a graphic data system file.

The medium can further comprise computer code for causing said at least one shape to be added to said library as a dummy library element. The computer code can also include code for instantiating as a final verilog or vhdl netlist, the data of said design, including data representative of said shapes. The medium can further comprise computer code for merging all data of the design into a graphic data system file, for all design components.

In accordance with another aspect, the invention is directed to a system for designing an integrated circuit, comprising a library of shapes, a plurality of said shapes being useful for defining regions of the integrated circuit in which no active chip circuits are placed; and a processor for utilizing the library to design the integrated circuit. The system can further comprising means for forming graphic data system data corresponding to the design of the integrated circuit, said graphic data system data including data representing said at least one shape. At least one shape can comprise a generally frame shape around the active region of an integrated circuit; and corner protect regions at the corners of the frame; wherein said frame shape and said corner regions do not overlap, but combine to form a rectangular frame around said active region of said integrated circuit.

The system will generally further comprise means for causing said at least one shape to conform to ground rules for design of the integrated circuit. The system can further comprise means for providing data files associated with the shapes, the data files including a verilog description, a library exchange format file and a graphic data system file.

The system also can further comprising means for instantiating the design, including said shapes, as a final verilog or vhdl netlist, as well as means for merging all data of the design into a graphic data system file, for all design components.

The invention is also directed to an integrated circuit design service comprising utilizing at least one of the method, media or system for designing an integrated circuit, as described above.

### BRIEF DESCRIPTION OF THE DRAWINGS

The foregoing aspects and other features of the present invention are explained in the following description, taken in connection with the accompanying drawings, wherein:

FIG. 1A is an enlarged plan view of an active chip region surrounded by regions in which no active chip circuitry may be placed.

FIG. 1B is a further enlarged plan view representation of one of the regions of FIG. 1A in which no active chip circuitry may be placed.

FIG. 2 is a table of rules for the design and use of the shapes of FIG. 1A and FIG. 1B.

FIG. 3 is a flow chart of the method in accordance with the invention.

FIG. 4 is a simplified block diagram of a computer system programmed in accordance with the invention.

### DETAILED DESCRIPTION OF THE PREFERRED EMBODIMENT

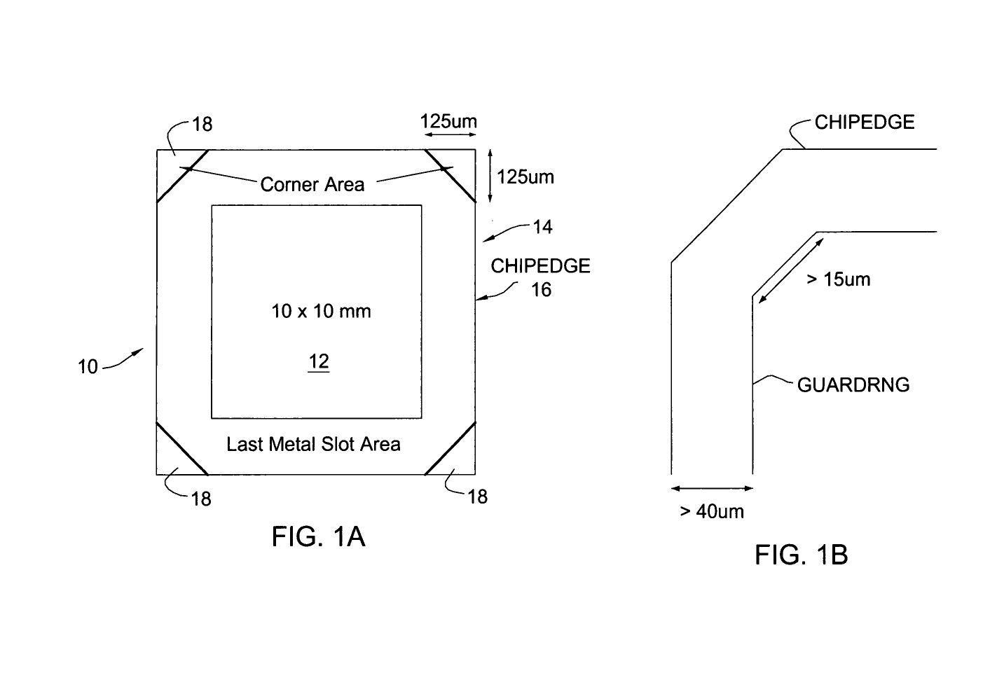

Referring to FIG. 1, there is shown a plan view of a region 10 of a silicon wafer on which an integrated circuit is to be formed. The integrated circuit has an active region 12 (shown as being 10 mm by 10 mm in size) in which circuitry may be formed, and a frame shaped border, shown generally as 14, wherein no circuitry may be formed. Boarder 14 is comprised of a first shape CHIPEDGE 16 and four corner shapes PROTECT 18.

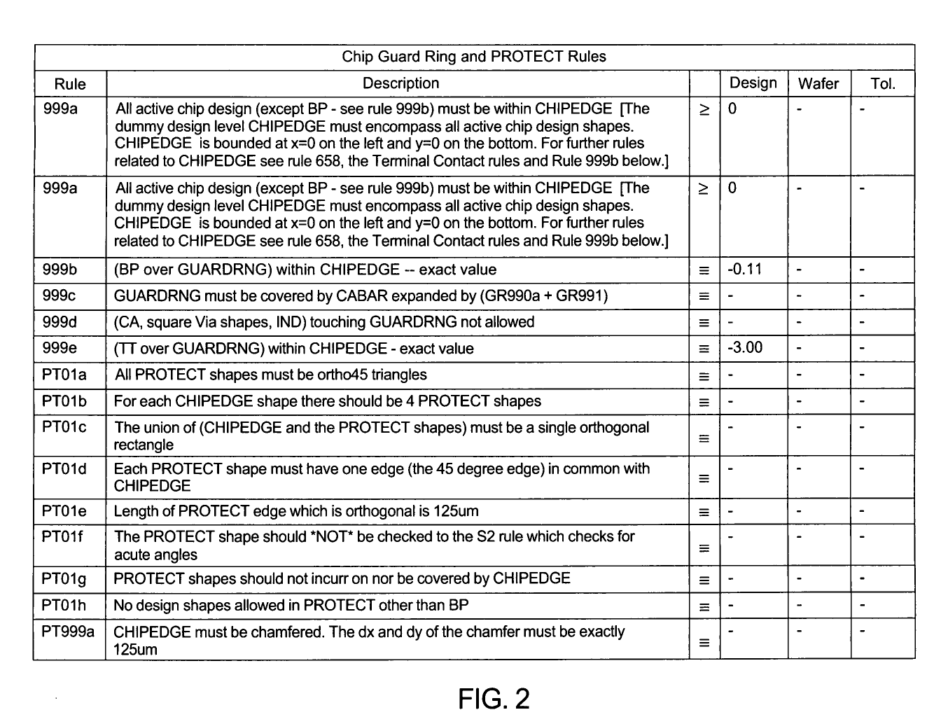

FIG. 2 is a table of the design rules associated with CHIPEDGE 16 and PROTECT 18 of FIG. 1A. This is a page from a Ground Rules document that is provided by International Business Machines Corporation to ASIC designers. All the terms associated with this page are explained in detail in the document, which is known as the “CMS9SF Design Manual”, which is incorporated herein in its entirety. It is available to all customers who are designing a chip for production in an IBM foundry. A similar manual may be available with specific ground rules for any other foundry.

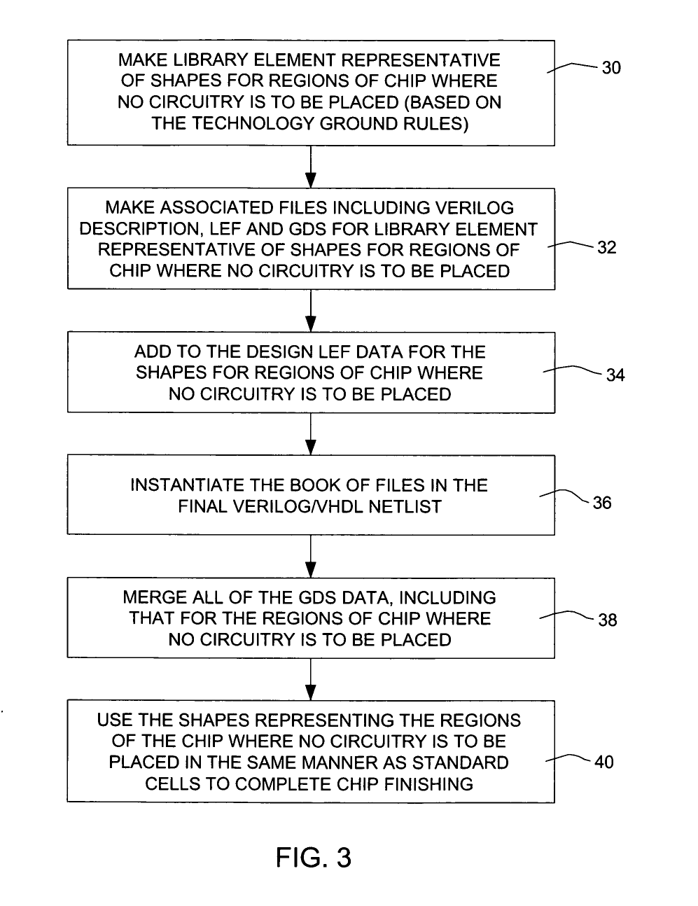

FIG. 3 illustrates the process according to the invention. At 30, library elements representative of shapes for regions of the chip where no circuitry is to be placed are created. These shapes are created based on the ground rules for the integrated circuitry technology being used. At 32, associated verilog description, LEF and GDS files are produced for the library elements representative of shapes for regions of the chip where no circuitry is to be placed. At 34, the data for the shapes representative of regions of the chip where no circuitry is to be placed are added to the design LEF. At 36, the book of files that were created are instantiated in the final verilog/vhdl netlist. At 38, all of the GDS data, including that for the regions of the regions of the chip where no circuitry is to be placed, are merged. At 40, the shapes representative of regions of the chip where no circuitry is to be placed are used in the same manner as standard cells to complete chip finishing.

The code for a LEF based dummy library element for PROTECT may include:

```
MACRO PRTCT
    CLASS CORE
    ORIGIN 0.000 0.000 ;
    SIZE 10.0 by 10.0 ;
    SYMMETRY x y ;
    SITE cmos90site
END PRTCT
```

An example of instantiating the PROTECT library element in verilog is:

PRTCT prtct_u1( );

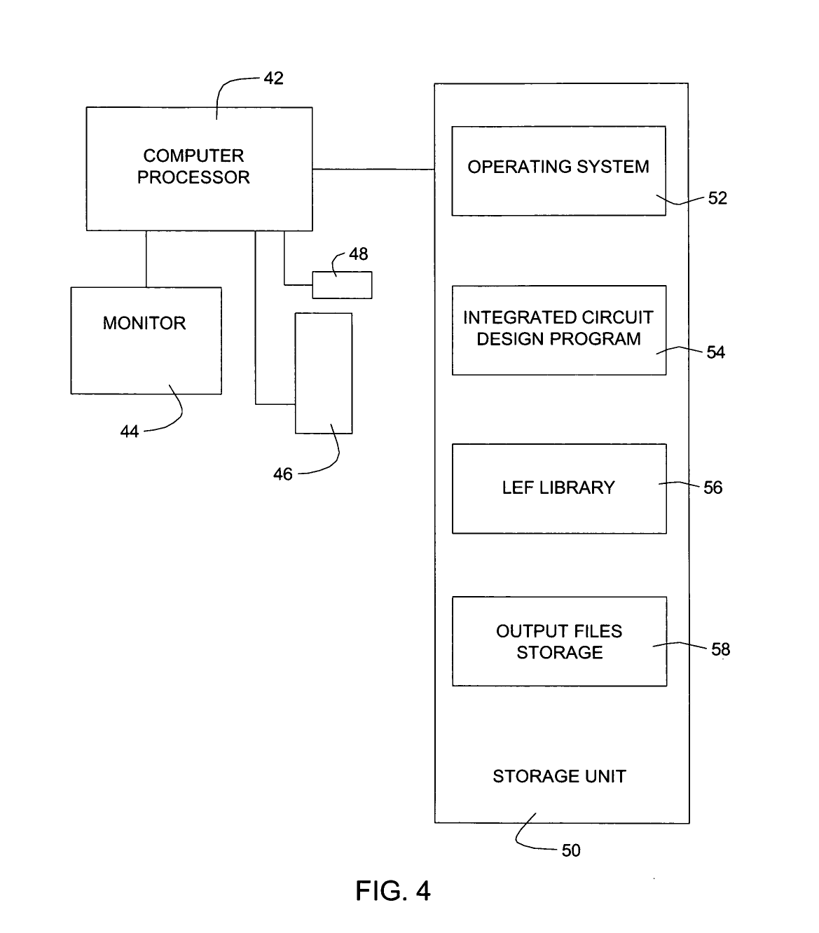

FIG. 4 is a simplified, high-level block diagram of a computer system (which may be one of a personal computer or a work station manufactured by International Business Machines Corporation) programmed in accordance with the invention. The computer processor 42 is connected in a conventional manner to a monitor 44, a keyboard 46 and a mouse 48. A storage unit, such as a hard drive 50, includes an operating system 52, and a number of applications (generally not shown) including an integrated circuit design program 54, such as that supplied by Cadence Design Systems, Inc. of San Jose, Calif., USA. The integrated circuit design program 54 includes a facility for an LEF library 56 having a database of standard cells used in designs, as well as those created by integrated circuit designers. In accordance with the invention, it includes the PROTECT shape, which is a dummy shape, where, as described above, no circuitry of the integrated circuit is placed. The integrated circuit design program 54 also includes a facility for output files storage 58, for storing such files as GDS and verilog/vhdl netlist files.

Thus, it is apparent that the present invention offers many advantages. First there is a substantial reduction in the number of man-hours required to complete a design (generally on the order of approximately ten percent). Second, the data representative of the shapes used to define regions of the integrated circuit in which no active chip circuits are placed can be reused, generally for all chips of the same technology, and independent of the nature of the design. Finally, the specification of these shapes can be accomplished early in the design cycle, and in parallel with other design tasks, thus expediting the overall design process.

Although the present invention has been described with reference to the embodiment shown in the drawings, it should be understood that the present invention can be embodied in many alternate forms of embodiments. In addition, any suitable size, shape or type of elements or materials could be used. For example, although the processing has been said to involve silicon based wafers and chips, it can be used with any semiconductor technology to design integrated circuits, although it will be understood that different technologies may have different sets of ground rules.

The present invention can be realized in hardware, software, or a combination of hardware and software. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods. Computer program means or computer program in the present context include any expression, in any language, code or notation, of a set of instructions intended to cause a system having an information processing capability to perform a particular function either directly or after conversion to another language, code or notation, and/or reproduction in a different material form.

Thus, the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for designing an integrated circuit, comprising:
providing in a library of shapes, at least one shape used to define regions of the integrated circuit in which no active chip circuits are placed; and
utilizing the library to design the integrated circuit.

2. The method of claim 1, further comprising forming graphic data system data corresponding to the design of the integrated circuit, said graphic data system data including data representing said at least one shape.

3. The method of claim 1, wherein said at least one shape comprises:
a generally frame shape around the active region of an integrated circuit; and
corner protect regions at the corners of the frame;
wherein said frame shape and said corner regions do not overlap, but combine to form a rectangular frame around said active region of said integrated circuit.

4. The method of claim 1, wherein said at least one shape conforms to ground rules for design of the integrated circuit.

5. The method of claim 1, further comprising providing data files associated with the shapes, the data files including a verilog description, a library exchange format file and a graphic data system file.

6. The method of claim 1, wherein at least one of said at least one shape is added to said library as a dummy library element.

7. The method of claim 1, wherein during the design process the design, including said shapes, is instantiated as a final verilog or vhdl netlist.

8. The method of claim 7, further comprising merging all data of the design into a graphic data system file, for all design components.

9. A computer readable medium having computer readable code thereon for causing a processor in a computer to perform steps in the design of an integrated circuit, the computer code causing the processor to perform steps comprising:
accessing in a library of shapes, a at least one shape used to define regions of the integrated circuit in which no active chip circuits are placed; and
utilizing the library to design the integrated circuit.

10. The computer readable medium of claim 9, further comprising computer code for forming graphic data system data corresponding to the design of the integrated circuit, said graphic data system data including data representing said at least one shape.

11. The computer readable medium of claim 9, further comprising computer code for causing one of said shapes to comprise:
a generally frame shape around the active region of an integrated circuit; and
corner protect regions at the corners of the frame;
wherein said frame shape and said corner regions do not overlap, but combine to form a rectangular frame around said active region of said integrated circuit.

12. The computer readable medium of claim 9, further comprising computer code for causing said at least one shape to conform to ground rules for design of the integrated circuit.

13. The computer readable medium of claim 9, further comprising computer code for providing data files associated with the shapes, the data files including a verilog description, a library exchange format file and a graphic data system file.

14. The computer readable medium of claim 9, further comprising computer code for causing said at least one shape to be added to said library as a dummy library element.

15. The computer readable medium of claim 9, further comprising computer code for instantiating as a final verilog or vhdl netlist, the data of said design, including data representative of said shapes.

16. The computer readable medium of claim 15, further comprising computer code for merging all data of the design into a graphic data system file, for all design components.

17. A system for designing an integrated circuit, comprising:
a library of shapes, a plurality of said shapes being useful for defining regions of the integrated circuit in which no active chip circuits are placed; and
a processor for utilizing the library to design the integrated circuit.

18. The system of claim 17, further comprising means for forming graphic data system data corresponding to the design of the integrated circuit, said graphic data system data including data representing said at least one shape.

19. The system of claim 17, wherein said at least one shape comprises:
a generally frame shape around the active region of an integrated circuit; and
corner protect regions at the corners of the frame;
wherein said frame shape and said corner regions do not overlap, but combine to form a rectangular frame around said active region of said integrated circuit.

20. The system of claim 17, further comprising means for causing said at least one shape to conform to ground rules for design of the integrated circuit.

21. The system of claim 17, further comprising means for providing data files associated with the shapes, the data files including a verilog description, a library exchange format file and a graphic data system file.

22. The system of claim 17, further comprising means for instantiating the design, including said shapes, as a final verilog or vhdl netlist.

23. The system of claim 22, further comprising means for merging all data of the design into a graphic data system file, for all design components.

24. An integrated circuit design service comprising utilizing the method of claim 1 for designing an integrated circuit.

25. An integrated circuit design service comprising utilizing the computer readable medium of claim 9 for designing an integrated circuit.

26. An integrated circuit design service comprising utilizing the system of claim 17 for designing an integrated circuit.
